(19) United States
(12) Patent Application Publication
(10) Pub. No.: US 2001/0024366 A1
(43) Pub. Date: Sep. 27, 2001

(54) Knife with illumination device and tape measure

(76) Inventor: Martin Chen, Chang Hua City (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 09/867,050

(22) Filed: May 29, 2001

Related U.S. Application Data
(63) Continuation-in-part of application No. 09/480,773, filed on Jan. 10, 2000.

(51) Int. Cl. F21V 33/00

(52) U.S. Cl. 362/119; 362/253

(57) ABSTRACT

A knife includes a casing including an arcuate end to form a handle of pistol grip type for grasp and a blade mounted in the casing. The blade is slidable relative to the casing to a position in which an end of the blade is exposed for cutting. The handle of the casing includes a compartment for receiving a tape measure. An illumination device is detachably attached to the casing to provide illumination when required.

### CROSS REFERENCE TO RELATED APPLICATION

This is a continuation-in-part application of U.S. patent application Ser. No. 09/480,773 filed on Jan. 10, 2000, which is now abandoned.

### BACKGROUND OF THE INVENTION

1. Field of the Invention

The present invention relates to a multifunctional knife, and more particularly to a multifunctional art designer knife having an illumination device and a tape measure attached thereto.

2. Description of the Related Art

A so-called art designer knife is usually used to cut paper, thin plastic boards, thin wood, plastic tubes, wires, etc. Nevertheless, the blade of an art designer knife is often stuck in the object during cutting, as current art designer knives are not easy to grasp and thus difficult to apply larger force. As a result, the art designer knife tends to slip from the user's hand when cutting an object with a wider width. In some cases the art designer knife must be used in a dark environment and the working condition might be poor since light source is not always available. In addition, a rule or tape measure might be required when using an art designer knife, yet carriage is a problem and the user often forgot where it is.

The present invention is intended to provide a multifunctional knife that mitigates and/or obviates the above problems.

### SUMMARY OF THE INVENTION

It is a primary object of the present invention to provide a knife that has an arcuate end suitable for grasp by the user.

It is another object of the present invention to provide a knife that has a tape measure mounted thereto for measurement.

It is a further object of the present invention to provide a knife that may provide illumination when required.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a multifunctional knife in accordance with the present invention.

FIG. 2 is an exploded perspective view of the multifunctional knife in accordance with the present invention.

FIG. 3 is a side view of the multifunctional knife in accordance with the present invention, wherein a casing half is removed to show inner structure.

FIG. 4 is a side view similar to FIG. 3, illustrating adjustment of the position of the blade.

FIG. 5 is an enlarged view taken along line 5-5 in FIG. 6, illustrating an illumination device attached to the knife.

FIG. 6 is a side view, partly sectioned, illustrating attachment of the illumination device to the multifunctional knife in accordance with the present invention.

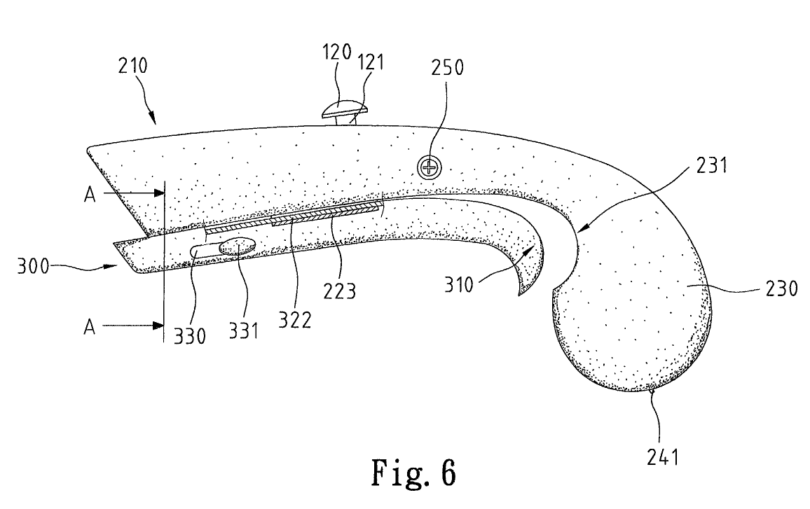

FIG. 7 is a side view, partly sectioned, of the multifunctional knife in accordance with the present invention, wherein the illumination device has already attached to the multifunctional knife.

FIG. 8 is a perspective view illustrating use of the illumination device and the multifunctional knife in accordance with the present invention.

### DETAILED DESCRIPTION OF THE PREFERRED EMBODIMENT

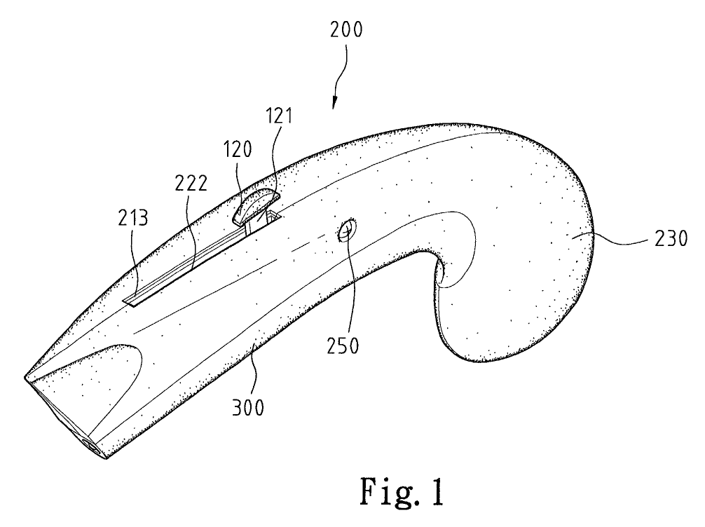

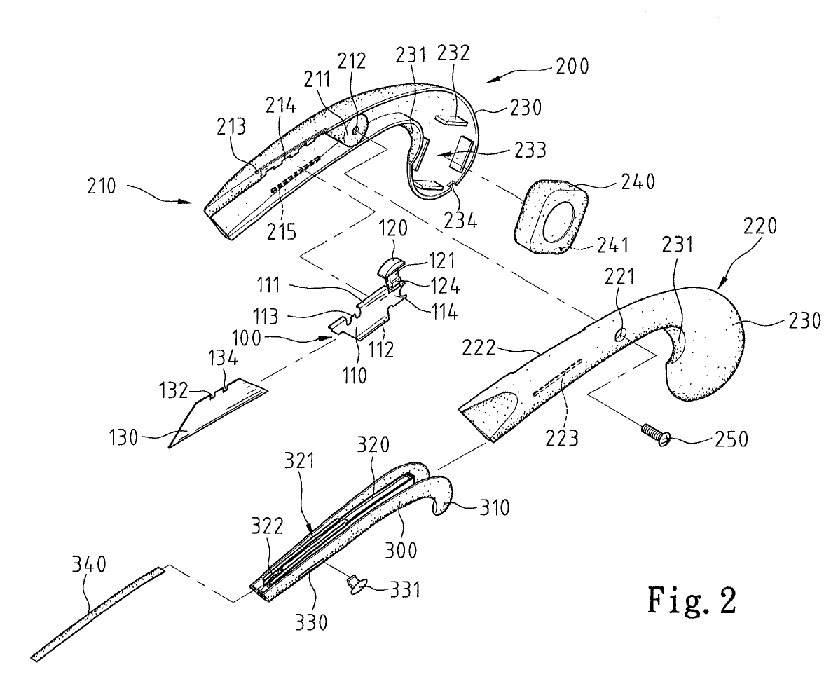

Referring to FIGS. 1 and 2, a multifunctional knife in accordance with the present invention generally includes a blade kit 100, a casing 200, and an illumination device 300. The blade kit 100 includes a blade holder 110 and a thumb piece 120. A blade 130 is mounted in the blade holder 110 and enclosed by upper and lower walls 111 and 112 of the blade holder 110 in a manner that the blade 130 cannot move in a vertical direction. The blade 130 has two recesses 132 and 134 in an upper side thereof. The upper wall 111 includes an engaging piece 113 for engaging with, e.g., recess 132 such that an end of the blade 130 may be used for cutting. When the end of the blade 130 becomes dull, the user may disengage the blade 130 from blade holder 110 and then flip-flop the blade 130 and re-insert the blade 130 into the blade holder 110 in a manner that the engaging piece 113 engages in the other recess 134 such that the other unused end of the blade 130 may be used.

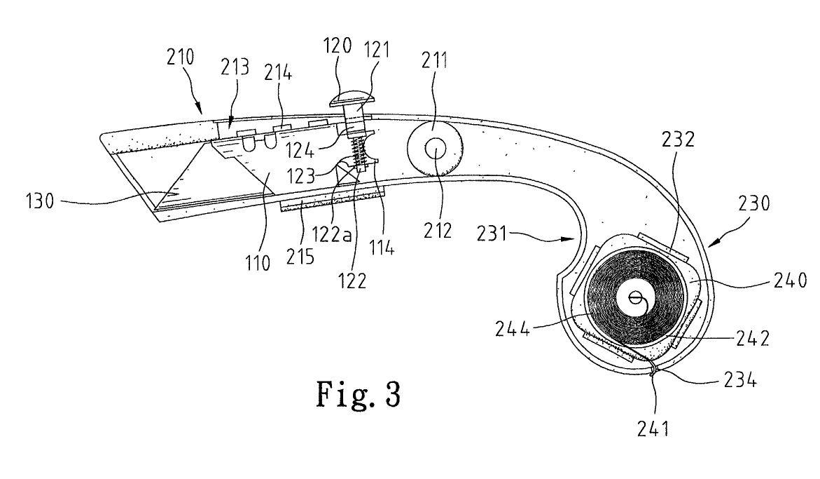

As illustrated in FIGS. 2 and 3, the thumb piece 120 includes a positioning member 121 and an engaging stem 122 extended from the positioning member 121. The positioning member 121 further includes two protrusions 124 formed on two sides thereof, respectively, which will be described later. The blade holder 110 includes a fixing seat 114 to which the engaging stem 122 is slidably mounted. An elastic element 123 is mounted around the engaging stem 122 for biasing the thumb piece 120 away from the fixing seat 114. Thus, the thumb piece 120 may be pressed downward, as the engaging stem 122 is slidably guided by the fixing seat 114 in the vertical direction. The engaging stem 122 may include a stop 122a (FIG. 3) located below the underside of the fixing seat 114 to thereby prevent disengagement of the thumb piece 120 from the fixing seat 114.

The casing 200 includes a first casing half 210 and a second casing half 220. Each casing half 210, 220 includes an arcuate end 230 that forms a handle of pistol grip type for grasp. The arcuate end 230 includes an arcuate recessed portion 231 in an inner side thereof. The first casing half 210 includes four positioning plates 232 in the arcuate end 230 thereof to thereby define a compartment 233 for receiving a tape measure 240 comprising a housing 242 and a flexible rule 244 coiled in the housing 242, best shown in FIG. 3. The arcuate end 230 includes a notch 234 through which an end hook 241 of the flexible rule 244 of the tape measure 240 is extended beyond the casing half 210 during assembly. The first casing half 210 further includes a stub 211 with a screw hole 212, and the second half casing 220 includes a through-hole 221. A screw 250 is extended through the through-hole 221 and the screw hole 212 to assemble the casing halves 210 and 220 together. After assembly of the casing halves 210 and 220, the end hook 241 of the tape measure 240 is prevented from entering the assembled casing 200. Preferably, the notch 234 on each arcuate end 230 is defined in a side of the casing half 210 that faces away from the blade 130, thereby allowing use of the tape measure 240 without interference by the blade 130. This also prevents the tape measure 240 from being severed by the blade 130 when in use.

Each casing half 210, 220 further includes a substantially L-shape rail 215, 223 formed on an underside thereof for engaging with the illumination device 300, which will be described later. Each casing half 210, 220 further includes an elongate groove 213, 222. The elongate grooves 213 and 222 together define an elongate slot when the casing halves 210 and 220 are assembled together. The thumb piece 120 may slide along the elongate slot for adjusting position of the blade 130, which will be described later. Below the elongate groove 213, 222, a number of positioning recesses 214 are defined in each casing half 210, 220 for releasably engaging with the protrusions 124 of the thumb piece 120 to thereby retain the blade 130 in place.

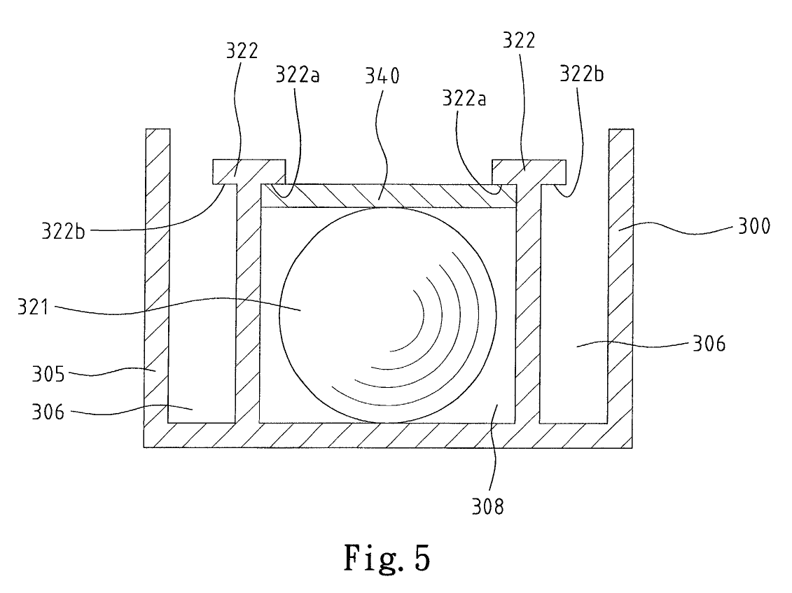

The illumination device 300 includes an end with an arcuate extension 310 for releasably engaging with the arcuate recessed portions 231 of the assembled casing halves 210 and 220. A compartment 320 is defined in the illumination device 300 for receiving an illumination means 321 that can be turned on/off by a switch 331 which, in turn, is extended through a slot 330 defined in a side of the illumination device 300. In this embodiment, as illustrated in FIG. 5, the illumination device 300 includes an outer U-shape wall 305 and two T-shape beams 322 projected from an intermediate section of the outer U-shape wall 305, thereby defining two outer chambers 306 and an inner chamber 308 in which the illumination means 321 is mounted. In addition, a slide lid 340 is slidably mounted into the inner chamber 308 to retain the illumination device 321 in place, and the slide lid 340 is in sliding contact with an inner shoulder section 322a of a distal end of each T-shape beam 322.

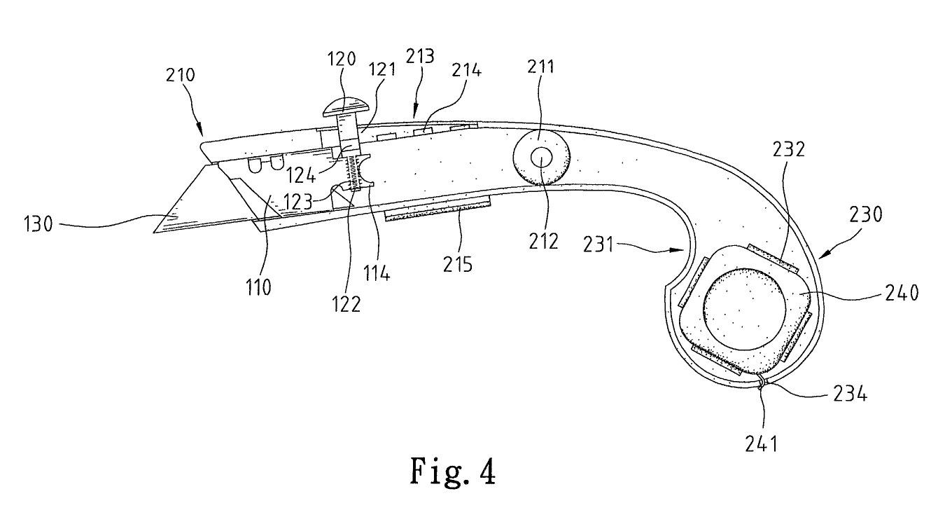

The blade 130 in FIG. 3 is in a storage position in which the protrusions 124 of the positioning member 121 are engaged with a pair of innermost positioning recesses 214 of the casing 200. When in use, the thumb piece 120 is pushed downward and thus compresses the elastic element 123. The protrusions 124 of the positioning member 121 are disengaged from the innermost positioning recesses 214. Then, the thumb piece 120 is moved along the elongate slot defined by elongated grooves 213 and 222 until the blade 130 is exposed to a desired extent. Next, the thumb piece 120 is released, and the protrusions 124 of the positioning member 121 engage another pair of the positioning recesses 214 of the casing 200 under the action of the elastic element 123, best shown in FIG. 4.

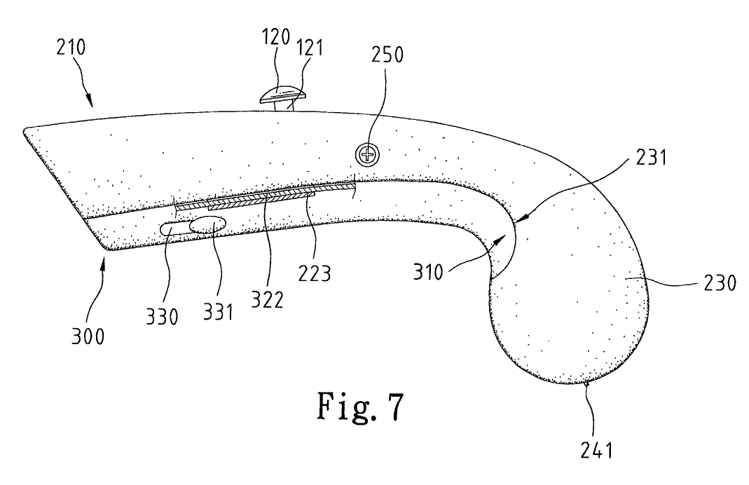

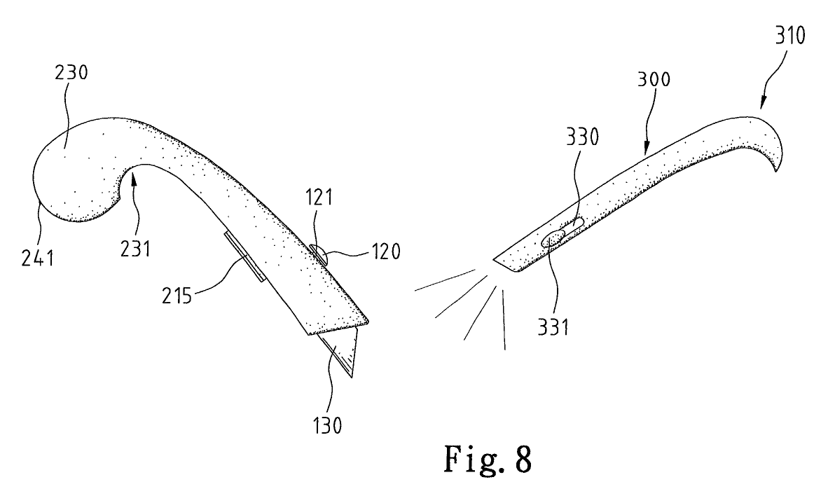

Referring to FIG. 5, the illumination device 300 may be attached to an underside of the casing 200. The outer chambers 306 of the illumination device 300 are aligned with the L-shape rails 215 and 223 of the casing 200, and the illumination device 300 and the casing 200 are then moved toward each other to allow sliding engagement between the outer chambers 306 and the L-shape rails 215. The illumination device 300 and the casing 200 are further moved toward each other until the arcuate extension 310 of the illumination device 300 engages with the arcuate recessed portions 231 of the casing 200, as shown in FIG. 7. It is noted that disengagement of the illumination device 300 from the casing 200 is prevented, as upward movement of the L-shape rails 215 and 223 are stopped by outer shoulder portions 322b (FIG. 5) of the T-shape beams 322, respectively. When required, the illumination device 300 may be detached from the casing 200 to provide illumination, as shown in FIG. 8.

According to the above description, it is appreciated that the knife in accordance with the present invention can be firmly grasped to provide easy cutting. In addition, the knife has a tape measure and an illumination device attached thereto, which is convenient to use. The tape measure 240 includes a housing 242 and a flexible rule 244 coiled in the housing 242, best shown in FIG. 3. This allows the user to incorporate a currently available tape measure 240 into the knife in accordance with the present invention.

Although the invention has been explained in relation to its preferred embodiment, it is to be understood that many other possible modifications and variations can be made without departing from the spirit and scope of the invention as hereinafter claimed.

What is claimed is:

1. A knife comprising:
a casing including an arcuate end to form a handle of pistol grip type for grasp; and
a blade mounted in the casing, the blade being slidable relative to the casing to a position in which an end of the blade is exposed for cutting.

2. The knife as claimed in claim 1, wherein the handle of the casing includes a compartment for receiving a tape measure.

3. The knife as claimed in claim 2, wherein the casing comprises a notch defined in a side thereof that faces away from the blade, the tape measure comprising a housing and a flexible rule, the flexible rule being coiled in the housing and extending through the notch

4. The knife as claimed in claim 1, further comprising an illumination device detachably attached to the casing.

5. The knife as claimed in claim 1, wherein the casing includes two casing halves.

6. The knife as claimed in claim 5, wherein one of the casing halves includes a compartment for receiving a tape measure comprising a housing and a flexible rule coiled in the housing and having an end hook, said one of the casing halves including a notch through which the end hook is extended beyond the casing, the end hook being prevented from entering the casing after the casing halves are assembled.

7. The knife as claimed in claim 6, wherein the notch is defined in a side of said one of the casing halves that faces away from the blade.

8. The knife as claimed in claim 5, further comprising an illumination device detachably attached to the casing.

9. The knife as claimed in claim 8, wherein at least one of the casing halves includes a rail, and wherein the illumination device includes means for slidably engaging with the rail.

10. The knife as claimed in claim 8, wherein the handle includes a recessed portion and wherein the illumination device includes an end sized to complimentarily engage with the recessed portion.

11. The knife as claimed in claim 9, wherein the handle includes a recessed portion and wherein the illumination device includes an end sized to complimentarily engage with the recessed portion.

12. A knife comprising:
a casing including two casing halves, each said casing half having a substantially L-shape rail formed on an underside thereof;
a blade mounted in the casing, the blade being slidable relative to the casing to a position in which an end of the blade is exposed for cutting; and
an illumination device including a substantially U-shape outer wall having an intermediate portion, two T-shape beams being projected from the intermediate section of the outer U-shape wall, thereby defining two outer chambers and an inner chamber, each said T-shape beam including an inner shoulder section located in the inner chamber and an outer shoulder section located in an associated said outer chamber, an illumination means being mounted in the inner chamber, a slide lid being slidably mounted in the inner chamber to retain the illumination device in place, the slide lid being is in sliding contact with the inner shoulder sections of the T-shape beams, and each said rail of the casing being in sliding contact with the outer shoulder section of an associated said T-shape beam.

13. The knife as claimed in claim 12, wherein each said casing half includes an arcuate end to form a handle for grasp.

14. The knife as claimed in claim 13, wherein the arcuate end of one of the casing halves includes a compartment therein for receiving a tape measure.

15. A knife comprising:
a casing including two casing halves, one of the casing halves including a plurality of positioning recesses, at least one of the casing halves defining an elongate slot, each said casing half having a substantially L-shape rail formed on an underside thereof;
a blade kit mounted in the casing, the blade kit including a blade, a blade holder for holding the blade, and a thumb piece extended beyond the casing for manual operation along the elongate slot, thereby moving the blade relative to the casing, the thumb piece including a positioning member and an engaging stem extended from the positioning member, the positioning member including a protrusion for releasably engaging with one of the positioning recesses of the casing, the blade holder including a fixing seat to which the engaging stem is slidably engaged such that the thumb piece is slidable in a vertical direction relative to the fixing seat to thereby allow the protrusion to be disengaged from the positioning recesses when the thumb piece is pushed, an elastic element being mounted around the engaging stem for biasing the protrusion to engage with said one of the positioning recesses of the casing; and
an illumination device including a substantially U-shape outer wall having an intermediate portion, two T-shape beams being projected from the intermediate section of the outer U-shape wall, thereby defining two outer chambers and an inner chamber, each said T-shape beam including an inner shoulder section located in the inner chamber and an outer shoulder section located in an associated said outer chamber, an illumination means being mounted in the inner chamber, a slide lid being slidably mounted in the inner chamber to retain the illumination device in place, the slide lid being is in sliding contact with the inner shoulder sections of the T-shape beams, and each said rail of the casing being in sliding contact with the outer shoulder section of an associated said T-shape beam.

16. The knife as claimed in claim 15, wherein each said casing half includes an arcuate end to form a handle for grasp.

17. The knife as claimed in claim 16, wherein the handle is of pistol grip type.

18. The knife as claimed in claim 16, wherein the arcuate end of one of the casing halves includes a compartment therein for receiving a tape measure.

19. The knife as claimed in claim 18, wherein the tape measure comprises a housing and a flexible rule coiled in the housing and having an end hook, said one of the casing halves including a notch through which the end hook is extended beyond the casing, the end hook being prevented from entering the casing after the casing halves are assembled.

20. The knife as claimed in claim 15, wherein the blade has two recesses and the blade holder includes an engaging piece for releasably engaging with one of the recesses of the knife, and wherein an end of the knife is usable when the engaging piece engages with one of the recesses of the knife, and the other end of the knife is usable when the engaging piece engages with the other recess of the knife.
